(19) United States
(12) Patent Application Publication
(10) Pub. No.: US 2016/0342540 A1
(43) Pub. Date: Nov. 24, 2016

(54) LOW LATENCY MEMORY AND BUS FREQUENCY SCALING BASED UPON HARDWARE MONITORING

(71) Applicant: Qualcomm Innovation Center, Inc., San Diego, CA (US)

(72) Inventor: Saravana Krishnan Kannan, San Diego, CA (US)

(21) Appl. No.: 15/159,402

(22) Filed: May 19, 2016

Related U.S. Application Data
(60) Provisional application No. 62/164,711, filed on May 21, 2015.
(60) Provisional application No. 62/197,406, filed on Jul. 27, 2015.

(51) Int. Cl. G06F 13/16; G06F 13/42; G06F 13/24; G06F 13/22

(52) U.S. Cl. CPC G06F 13/161; G06F 13/22; G06F 13/4282; G06F 13/24

(57) ABSTRACT

Systems and methods for controlling a frequency of system memory and/or system bus on a computing device are disclosed. The method may include monitoring a number of read/write events occurring in connection with a hardware device during a length of time with a performance counter and calculating an effective data transfer rate based upon the amount of data transferred. The method also includes periodically adjusting a frequency of at least one of the system memory and the system bus based upon the effective data transfer rate and dynamically tuning a threshold number of events that trigger an interrupt based upon a history of the number of read/write events. In addition, the method includes receiving the interrupt from the performance counter when the threshold number of read/write events occurs and adjusting the frequency of at least one of the system memory and the system bus when the interrupt occurs.

### CLAIM OF PRIORITY UNDER 35 U.S.C. §119

The present application for patent claims priority to Provisional Application No. 62/164,711 and 62/197,406 entitled “Low Latency Memory and Bus Frequency Scaling Based Upon Hardware Monitoring” filed May 21, 2015 and Jul. 27, 2015, respectively, and assigned to the assignee hereof and hereby expressly incorporated by reference herein.

### BACKGROUND

I. Field of the Disclosure

The technology of the disclosure relates generally to data transfer between hardware devices and system memory constructs via an electronic bus, and more particularly to control of the electronic bus and memory frequencies.

II. Background

Electronic devices, such as mobile phones, personal digital assistants (PDAs), and the like, are commonly manufactured using application specific integrated circuit (ASIC) designs. Developments in achieving high levels of silicon integration have allowed creation of complicated ASICs and field programmable gate array (FPGA) designs. These ASICs and FPGAs may be provided in a single chip to provide a system-on-a-chip (SOC). An SOC provides multiple functioning subsystems on a single semiconductor chip, such as for example, processors, multipliers, caches, and other electronic components. SOCs are particularly useful in portable electronic devices because of their integration of multiple subsystems that can provide multiple features and applications in a single chip. Further, SOCs may allow smaller portable electronic devices by use of a single chip that may otherwise have been provided using multiple chips.

To communicatively interface multiple diverse components or subsystems together within a circuit provided on a chip(s), which may be an SOC as an example, an interconnect communications bus, also referred to herein simply as a bus, is provided. The bus is provided using circuitry, including clocked circuitry, which may include as examples registers, queues, and other circuits to manage communications between the various subsystems. The circuitry in the bus is clocked with one or more clock signals generated from a master clock signal that operates at the desired bus clock frequency(ies) to provide the throughput desired. In addition, system memory (e.g., DDR memory) is also clocked with one or more clock signals to provide a desired level of memory frequency.

In applications where reduced power consumption is desirable, the bus clock frequency and memory clock frequency can be lowered, but lowering the bus and memory clock frequencies lowers performance of the bus and memory, respectively. If lowering the clock frequencies of the bus and memory increases latencies beyond latency requirements or conditions for the subsystems coupled to the bus interconnect, the performance of the subsystem may degrade or fail entirely. Rather than risk degradation or failure, the bus clock and memory clock may be set to higher frequencies to reduce latency and provide performance margin, but providing higher bus and memory clock frequencies consumes more power.

### SUMMARY

Aspects of the present invention may be characterized as a method for controlling memory and/or bus frequency on a computing device. The method includes computing, within each of a plurality of decision loops, a maximum data throughput between a hardware device and the system memory, each decision loop lasting for a decision-loop-duration. The method also includes monitoring, within each decision loop, during a plurality of short sample loops, a maximum number of bytes transferred, via the system bus, to and from a hardware device to enable the computing of the maximum data throughput between the hardware device and system memory, wherein each of the short sample loops lasts for a sample-loop-duration. After each decision loop, a throughput vote for the hardware device is generated and the frequency of at least one of system memory and a system bus is adjusted based upon an aggregation of votes including the throughput vote for the hardware device.

Other aspects may be characterized as a computing device that includes a hardware device, system memory coupled to the hardware device, a system bus coupled between the system memory to the hardware device, and a counter coupled to the hardware device. The computing device also includes a memory access monitor coupled to the counter that is configured to compute, within each of a plurality of decision loops, a maximum data throughput between a hardware device and the system memory, each decision loop lasting for a decision-loop-duration. The memory access monitor also monitors within each decision loop, during a plurality of short sample loops, a number of bytes transferred, via the system bus, to and from a hardware device to enable the computing of the maximum data throughput between the hardware device and system memory, wherein each of the short sample loops lasts for a sample-loop-duration. After each decision loop, the memory access monitor generates a throughput vote for the hardware device. A memory frequency control module controls the frequency of system memory based upon an aggregation of votes including the throughput vote for the hardware device.

Yet another aspect may be characterized as a non-transitory, tangible processor readable storage medium, encoded with processor readable instructions to perform a method for controlling frequency of system memory and/or a system bus on a computing device. The method includes computing, within each of a plurality of decision loops, a maximum data throughput between a hardware device and the system memory, each decision loop lasting for a decision-loop-duration. The method also includes monitoring, during a plurality of short sample loops within each decision loop, a number of bytes transferred, via the system bus, to and from a hardware device to enable the computing of the maximum data throughput between the hardware device and system memory, wherein each of the short sample loops lasts for a sample-loop-duration. After each decision loop, a throughput vote for the hardware device is generated and the frequency of at least one of system memory and a system bus is adjusted based upon an aggregation of votes including the throughput vote for the hardware device.

### BRIEF DESCRIPTION OF THE FIGURES

FIG. 1 is a block diagram that generally depicts functional components of an exemplary embodiment;

FIG. 2 is a block diagram of an exemplary processor-based system that may be utilized in connection with many embodiments;

FIG. 3 is a block diagram depicting an embodiment of the MAMs depicted in FIG. 1;

FIG. 4 is a is a flowchart depicting a method that may be carried out in connection with embodiments disclosed herein;

FIG. 5 is a graph depicting an operational aspect of an embodiment;

FIG. 6A is a graph depicting aspects of the prior art;

FIG. 6B is a graph depicting operational aspects of embodiments disclosed herein;

FIG. 7 is a graph depicting voting and throughput as a function of time;

FIG. 8A is a graph depicting operation without idle detection;

FIG. 8B is a graph depicting operation with idle detection;

FIGS. 9A and 9B depict voting as a function of throughput according to aspects disclosed herein;

FIG. 10 is a block diagram depicting components that are implemented in both hardware and software; and

FIG. 11 is a block diagram depicting an embodiment with components implemented in hardware.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

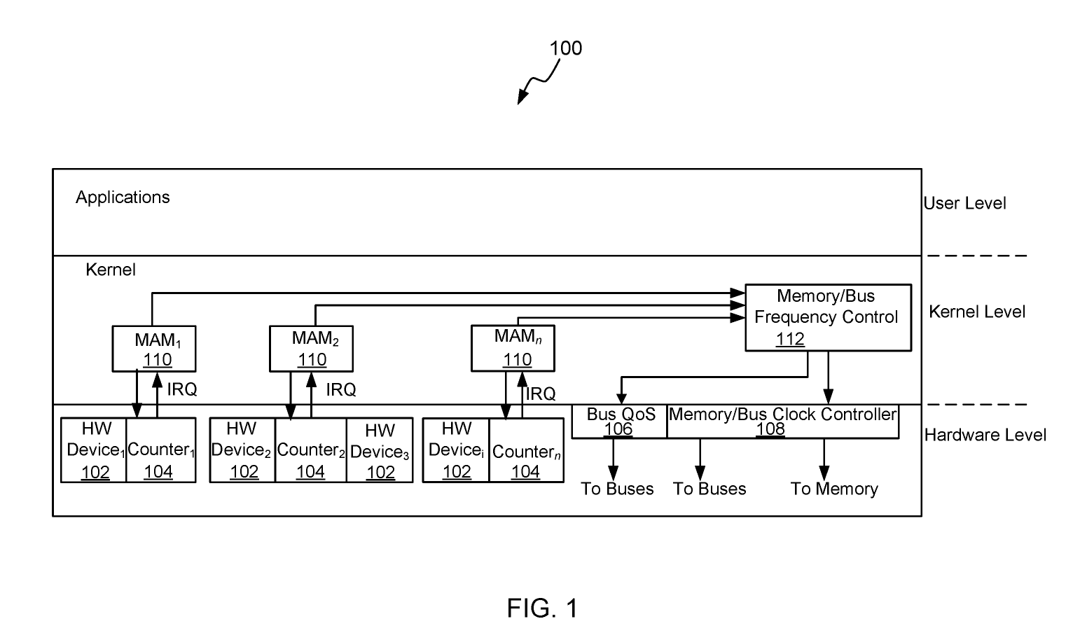

Referring to FIG. 1, shown is a computing device 100 depicted in terms of abstraction layers from hardware to a user level. The computing device 100 may be implemented as any of a variety of different types of devices including smart phones, tablets, netbooks, set top boxes, entertainment units, navigation devices, and personal digital assistants, etc. As depicted, applications at the user level operate above the kernel level, which is disposed between the user level and the hardware level. In general, the applications at the user level enable a user of the computing device 100 to interact with the computing device 100 in a user-friendly manner, and the kernel level provides a platform for the applications to interact with the hardware level.

As depicted, in the hardware level a quantity of i hardware devices 102 (e.g., one or more hardware devices) reside with a quantity of n performance counters 104 (also referred to herein simply as counters). In general, each of the hardware devices 102 is capable of reading and/or writing to system memory (e.g., DDR memory) via a data bus (e.g., system bus or multimedia bus), and each of the depicted counters 104 provides an indication of a number of read/write events that are occurring (e.g., between a hardware device and system memory). Also depicted at the hardware level are a bus quality of service (QoS) component 106, and a memory/bus clock controller 108.

At the kernel level, a collection of n memory-access monitors (“MAMs”) 110 are in communication with a memory/bus frequency control component 112 that is in communication with the bus QoS component 106 and the memory/bus clock controller 108. In the depicted embodiment the memory/bus frequency controller 112 may be realized by components (e.g., a bus driver) implemented in the kernel (e.g., LINUX kernel), and the memory-access monitors 110 may be realized by additions to the LINUX kernel to effectuate the functions described herein. As depicted, each of the memory-access monitors 110 is in communication with one or more counters 104 to enable the memory-access monitors 110 to configure the counter(s) 104 and to enable the memory-access monitors 110 to receive interrupts from the counter(s) 104. In turn, the memory-access monitors 110 communicate frequency requirement information (e.g., by sending throughput votes) to the memory/bus frequency controller 112 and in turn, the memory/bus frequency control component 112 aggregates all of the inputs (e.g., votes) from all of the memory-access monitors 110 to determine a final frequency for the memory and busses. The memory/bus frequency controller 112 then controls 112 the bus QoS controller 106 and the memory/bus clock controller 108 (as described further herein) to effectuate the desired bus and/or memory frequencies.

It should be recognized that the depiction of components in FIG. 1 is a logical depiction and is not intended to depict discrete software or hardware components, and in addition, the depicted components in some instances may be separated or combined. For example, the depiction of distributed memory-access components 110 is exemplary only, and in some implementations the memory-access components 110 may be combined into a unitary module. In addition, it should be recognized that each of the depicted counters 104 may represent two or more counters 104, and the counters 104 associated with each hardware device 102 may be distributed about the computing device 100.

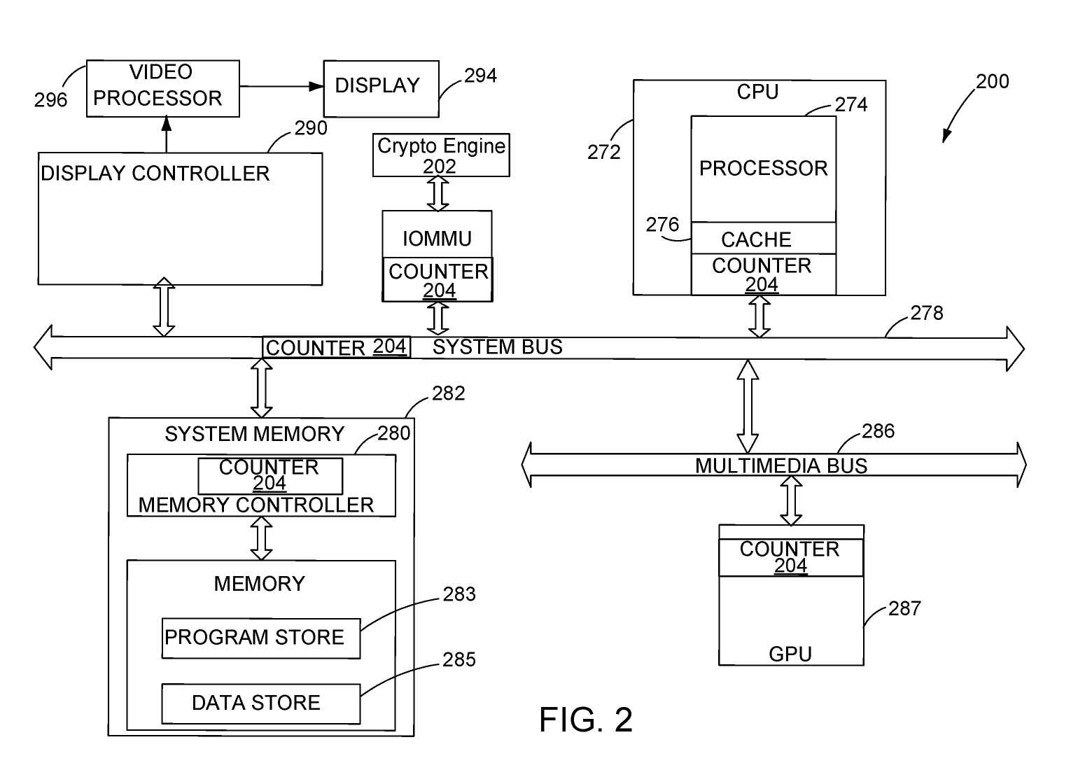

Referring to FIG. 2 for example, shown is a processor-based system 200 that includes a distribution of counters 204 and exemplary hardware devices such as a graphics processing unit (“GPU”) 287, a memory controller 280, a crypto engine 202 (also generally referred to as a hardware device 202), and one or more central processing units (CPUs) 272, each including one or more processors 274. The CPU(s) 272 may have cache memory 276 coupled to the processor(s) 274 for rapid access to temporarily stored data. The CPU(s) 272 is coupled to a system bus 278 and can inter-couple master devices (e.g., hardware devices such as CPU 272, GPU 287, and crypto engine 202) and slave devices (e.g., system memory 282) included in the processor-based system 270. As is well known, the CPU(s) 272 communicates with these other devices by exchanging address, control, and data information over the system bus 278. For example, the CPU(s) 272 can communicate bus transaction requests to the memory controller 280 as an example of a slave device. In addition to the system bus 278, the processor-based system 200 includes a multimedia bus 286 that is coupled to the GPU 287 hardware device and the system bus 278. Although not illustrated in FIG. 2, multiple system buses 278 could also be provided, wherein each system bus 278 constitutes a different fabric.

As illustrated in FIG. 2, the system 200 may also include a system memory 282 (which can include program store 283 and/or data store 285). Although not depicted, the system 200 may include one or more input devices, one or more output devices, one or more network interface devices, and one or more display controllers. The input device(s) can include any type of input device, including but not limited to input keys, switches, voice processors, etc. The output device(s) can include any type of output device, including but not limited to audio, video, other visual indicators, etc. The network interface device(s) can be any devices configured to allow exchange of data to and from a network. The network can be any type of network, including but not limited to a wired or wireless network, private or public network, a local area network (LAN), a wide local area network (WLAN), and the Internet. The network interface device(s) can be configured to support any type of communication protocol desired.

The CPU 272 may also be configured to access the display controller(s) 290 over the system bus 278 to control information sent to one or more displays 294. The display controller(s) 290 sends information to the display(s) 294 to be displayed via one or more video processors 296, which process the information to be displayed into a format suitable for the display(s) 294. The display(s) 294 can include any type of display, including but not limited to a cathode ray tube (CRT), a liquid crystal display (LCD), a plasma display, etc.

In general, the memory-access monitors 110 in connection with the memory/bus frequency controller 112 allow the frequency of the system bus 278 and/or memory 282 to be dynamically scaled based on the memory access rate—independent of the execution/instruction load on the hardware devices (e.g., crypto engine 202, CPU 272, and GPU 287). As a consequence, when the CPU 272 is performing intensive work that requires little access to memory 282, the memory and/or bus frequencies may be kept low. This is a substantial benefit over prior approaches that adjust the frequency of the memory 282 based on the CPU 272 frequency even if the memory access rate from the CPU 272 is low. The crypto engine 202 generally operates to encrypt and decrypt data without using the CPU 272. It should be recognized that the crypto engine 202 is merely an example of the type hardware device that may be coupled to the system bus 278, but for clarity hardware devices other than the crypto engine 202, CPU 272, and GPU 287 are not depicted in FIG. 2.

In some embodiments, the final frequency of system memory 282 (e.g., DDR memory) and busses (e.g., system bus 278) are determined, at least in part, by aggregating the AB/IB votes from the MAMs 110. Although the focus of the methodologies disclosed herein relates to how the MAMs 110 determine their respective votes, it should be recognized that the memory/bus frequency controller 112 may also receive votes from other clients/modules. For example, video decoder hardware may indicate (with its votes) that it needs 5 GB per second without doing any memory monitoring.

Both AB (average throughput) and IB (instantaneous throughput) are specified in terms of B/s (bytes per second). An AB vote from a MAM 110 (corresponding to one of the bus master hardware devices 102) is an indication of the average throughput of data transfer that the bus master expects to do with the memory. Whereas, IB is an indication of the amount of latency that the bus master is willing to tolerate. Individual AB/IB values can be converted to the corresponding frequency requirements based on the bus width and the number of channels. To give a simplified view of the aggregation done by the memory/bus frequency control component 112:

Aggregated AB=sum of AB votes from the different MAMs 110; and

Aggregated IB=max of IB votes from the different MAMs 110.

In some embodiments, DDR frequency=Minimum frequency required to support max(aggregate AB, aggregated IB). For example, the final DDR frequency may be equal to max (sum (AB_{1 . . . n}), max(IB_{1 . . . n})) where ABₙ and IBₙ are AB and IB votes from one of the n MAMs 110.

For the sake of giving specific examples, the rest of this section will discuss memory throughput (BW) votes from the perspective of the CPU 272 (also referred to as an application processor subsystem (APSS)). However all the examples provided below apply to other hardware devices 102 that operate as bus masters such as the GPU 287, crypto engine 202 etc.

Low Latency Memory and Bus Scaling Based on Hardware Monitoring with High Sampling Rate

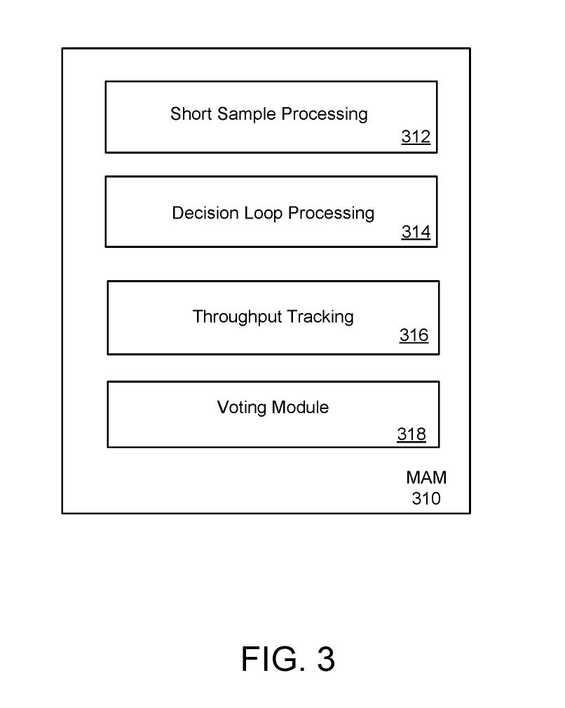

Referring next to FIG. 3, shown is an example of functional components of a memory access module 310 that may be utilized to realize the memory access modules 110 shown in FIG. 1. In some embodiments these functional components are realized by processor-executable instructions embodied in a non-transitory processor readable media (e.g., non-volatile memory), and in other embodiments, the functional components may be realized by hardware constructs. In yet other embodiments, the MAM 310 may be realized by a combination of processor-executable instructions and hardware. It should be recognized that FIG. 3 is intended to represent functions of embodiments disclosed herein, and each block may be realized by components distributed across a computing device (e.g., the computing device 100). Multiple components depicted in FIG. 3 may also be realized by a collection integrated components.

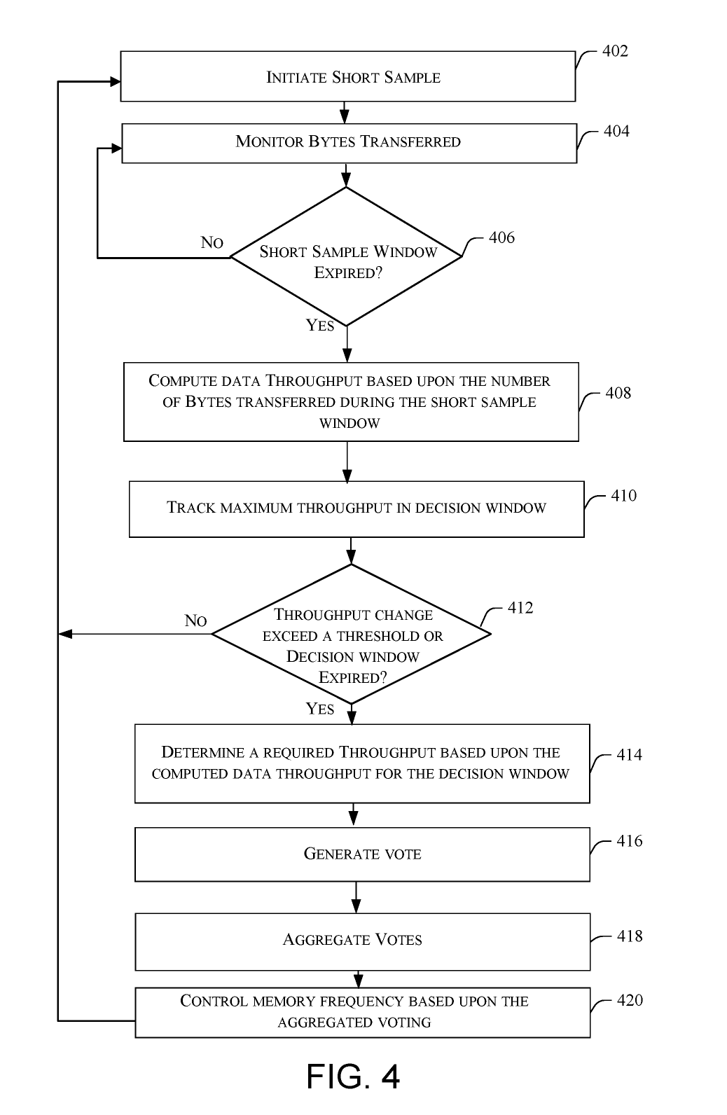

While referring to FIGS. 1-3, simultaneous reference is made to FIG. 4, which is a flowchart depicting a method that may be carried out in connection with embodiments disclosed herein. At a high level, the method depicted in FIG. 4 (and derivative scaling algorithms disclosed herein) revolve around using hardware counters 104 and/or additional hardware logic to measure and monitor the read/write throughput of traffic between a hardware (HW) device 102 bus master (CPU, GPU, etc.), and the memory (e.g., system memory 282) at a very high sampling rate (back to back short sample windows) to get a higher resolution picture of the traffic.

As shown in FIGS. 3 and 4, for example, the short sample processing module 312 generally functions to obtain a high resolution representation of the traffic and initiates a short sample window at Block 402, and the counter 104 iteratively monitors (Block 404) a number of bytes transferred from a hardware device 102 to memory in the short sample window until the short sample window has expired (Block 406). The short sample processing module 312 then computes the throughput between a hardware device 102 and memory (e.g., system memory 282) based upon the number of bytes transferred in the short sample window (Block 408) and the time length of the short sample window.

As shown in FIGS. 3 and 4, within each decision window, the decision loop processing module 314 in connection with the short sample processing module 312 may track the maximum throughput (bytes per second) seen among all the short sample windows within the decision window (Block 410) until either there is a change in throughput that exceeds a threshold or the decision window expires (Block 412). It should be recognized that the change in throughput (in Block 412) may be an increase in throughput or a decrease in throughput. It should also be recognized that the threshold for an increase in throughput may be different than the threshold for a decrease in throughput.

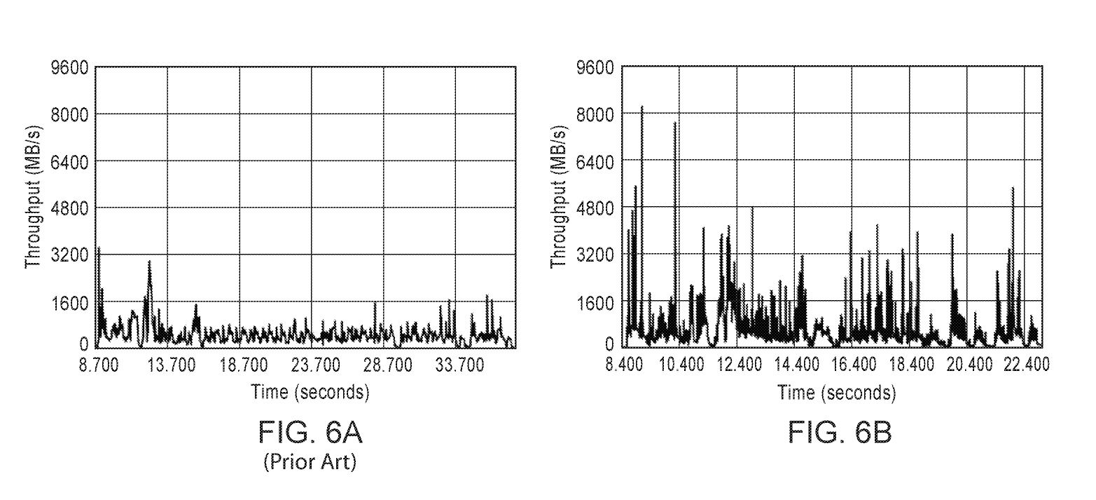

The higher resolution picture of the traffic is then used by the throughput tracking module 316 every decision window to differentiate between peaks, troughs, patterns of peaks and troughs, and steady state traffic to enable the voting module 318 to generate throughput vote (AB, IB) decisions. The decision window can be, and generally is, larger than the short sample window. The short sample window allows for quick, low latency reaction time by cutting short the decision window when the load changes significantly. Referring briefly to FIGS. 6A and 6B, which depict prior art and higher resolution measurements of throughput over time, respectively, the peaks, troughs, and patterns of peaks and troughs are much more apparent in the higher resolution of FIG. 6B provided by the method described with reference to FIG. 4. Thus, the underlying data utilized by the voting module 318 (to generate throughput vote (AB, IB) decisions) is much more aligned with the actual throughput, which allows for more optimal voting.

In general, the decision window (which has a decision-loop-duration) is a longer duration than the short sample window (which has a sample-loop-duration). As an example, a decision window of 50 milliseconds with a 1 to 2, or 2 to 4, millisecond short sample window of the short sample loop (Blocks 402-406) is considered a high resolution short sample window and performing the short sample loop back to back within the decision window of the decision loop (Blocks 402-412) is considered a high sampling rate. The decision window may also be 10 or 20 milliseconds, and the short sample window may be 10 milliseconds. But if the short sample window is 10 milliseconds, it may be preferable to set decision window to a duration that is greater than 10 milliseconds. This classification is subjective to current generation of software and hardware capabilities, but could be made smaller and faster in the future. What is considered a short sample window (and how short it can be) is affected by various hardware characteristics such as the time it takes to do a memory and bus frequency switch, the maximum read/write throughput a bus master can generate, the burstiness of the workload running in a bus master, and the maximum memory and bus capacity. As a specific example, in connection with the GPU 287, it may be beneficial to set the short sample window to be 10 milliseconds while a short sample window of less than 10 milliseconds is better suited for the CPU 272.

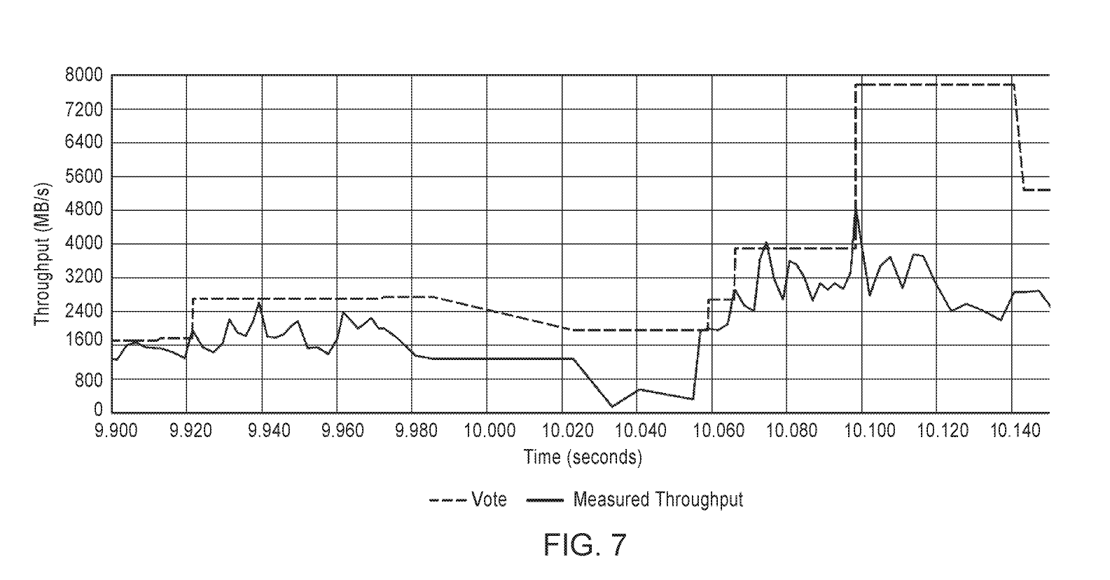

Referring briefly to FIG. 7, shown is a graph depicting the resultant fast reaction time of the voting due to the relatively short duration (e.g., 2 ms) of the sample windows.

The subsequent subsections describe various aspects and optional optimizations of the method that is generally depicted in FIG. 4 in small easy to understand components. Each subsection builds up on top of the previous subsection, so each subsection is best read in order.

### Decision Window and Short Sample Window

While each MAM 110 measures the throughput every short sample window (Blocks 402-408), it determines a required throughput based upon the computed data throughput for the decision window (Block 414). In some embodiments, the required throughput is determined to be the maximum throughput in the decision window. In other embodiments, the approach to determining the required throughput depends upon how the throughput varies within the decision window. In these other embodiments, for example, the required throughput may generally be equal to the maximum throughput for the decision window unless the decision window is terminated early (because the throughput drops so as to exceed the change threshold at Block 412). In the event of an early termination of the decision window, the required throughput may be determined based upon the measurements in the short sample loop after the throughput drop. In one embodiment, if the throughput falls to threshold throughout of 1000 MB/second (or less) for a threshold number of short sample windows, (e.g., five short sample windows), then the vote is based upon 1000 MB/second or the maximum throughput value measured under 1000 MB/second.

For example, if the down-change threshold at Block 412 is 20 percent of the current vote for five consecutive short sample windows, the current vote is 5000 MB/second, and following measurements (in MB/second) in the short sample loop occur: 4500, 4900, 4600, 4800, 900, 850, 830, 910, and 700, then the decision window is terminated early after the 700 MB/second short sample window because the change from 4800 to 900 MB/second is a drop to throughput lower than 20 percent of the current vote and there are five consecutive windows of short samples that are less than 1000 MB/s, and the vote would be reduced from 5000 MB/s to 910 MB/s and not 4900 MB/s even though all the samples above are a part of the same decision window.

As shown in FIGS. 3 and 4, the voting module 318 generates the throughput votes (Block 416) only at the end of every decision window (after Blocks 402-412). This is because changing the throughput votes for every short sample window would be wasteful because an inordinate amount time might be spent changing the memory and bus frequencies instead of actually doing useful work.

As shown in FIG. 4, the memory/bus frequency control component 112 aggregates the votes from the MAMs 110 (Block 418) and controls the memory frequency based upon the aggregated voting (Block 420).

Each of the MAMs 110 enables an upper bound to be set on the decision window when there is fairly steady traffic between a corresponding hardware device 102 and the memory, but the decision window may be shortened if the traffic changes significantly (e.g., when the change in the traffic exceeds a threshold). When there is no traffic between the master hardware device 102 and memory, the decision window may be indefinitely extended because there are no more decisions to make when there is no traffic and the MAMs 110 have already voted for the lowest (or zero) throughput.

### Measuring the Throughput Every Short Sample Window

Each of the HW counters 104, 204 is set up to measure the read/writes that happen between a corresponding HW device 102 and memory. Under some hardware configurations, the counters 104, 204 may also end up counting read/writes from the CPU 272 to device registers or internal memory. But the percentage of these compared to the read/writes to memory (e.g., DDR memory) are insignificant, and hence, do not affect the outcome of the algorithm by any significant amount.

The following steps may be performed at the end of each short sample window (Block 406):
a. The counters 104 are stopped;
b. The counters 104 are read to get the number of bytes that were transferred; (read/written) since the previous short sample window;
c. The current time is captured;
d. The actual short sample period is computed by subtracting the “timestamp of the previous short sample” from the current time;
e. The current time is stored as the “timestamp of previous short sample;”
f. The measured throughput is computed as:
g. short_sample_mbps=number of bytes transferred/actual short sample period;
h. The counters are reset to zero and the counters are restarted;
i. If the short_sample_mbps meets certain criteria (as described in more detail herein) the current decision window is terminated early by ending it at the end of the current short sample window.

### Smart Stretching of Short Sample Windows to Reduce Overhead

Depending on the extent of hardware support, measuring the traffic throughput in short sample widows can be implemented in multiple ways. This section describes a way to measure traffic throughput in short sample windows when the hardware monitors (e.g., the counters 104) only support counting the number of bytes read/written between the bus master HW device 102 and memory with support for a threshold IRQ when the count exceeds a threshold. In such cases, having software-implemented MAMs 110 set up a timer to sample the counters 104 every short_sample_window (e.g., 2 ms) may create a lot of software overhead that applies to all types of work loads.

An approach to reduce software overhead is to follow the configured sample-loop-duration (short_sample_window) of the short sample window when the throughput of the traffic is at its highest for a decision window and stretch (i.e., increase in duration) the sample-loop-duration when the traffic is not at its highest during a decision window. This reduces the software overhead (because there are fewer interruptions per decision window) without impacting performance.

To achieve this, the threshold IRQ may be used as an indirect means to achieve a short_sample_window timer that stretches or contracts based on the traffic generated by the workload. This is done by resetting the counter to zero every short sample window and setting the counter threshold as such:

threshold=max_mbps*short_sample_window;

Where,
max_mbps is the max throughput measured in any short sample loop within the previous decision window;
short_sample_window is the configured sample-loop-duration (e.g., the time period of each short sample window); and
the arrival of the threshold IRQ indicates the end of a short sample window.

For example, if the maximum throughput measured in a decision window is 10000 MB/s and the short sample window is 2 ms, then the threshold would be set to 10000*(2/1000)=20 MB. So, if the traffic throughput stays at 10000 MB/s, the threshold IRQ will continue to come every 2 ms. However, if the traffic throughput increases, the threshold IRQ would come sooner and provide a reaction latency that is even shorter than the 2 ms. Similarly, when the traffic throughput decreases to 5000 MB/s, the threshold IRQ would come every 4 ms.

However, when the workload on the master HW device 102 is not memory intensive (e.g., a CPU intensive workload on a CPU that generates 1 to 5 MB/s of traffic), the benefits of measuring the traffic throughput in short sample windows (e.g., lower latency and higher resolution) diminishes even when the traffic is the highest (e.g., 5 MB/s) for that decision window. This is because the throughput AB vote is already at its lowest valid value (e.g., 100 MB/s) and the lowest value is more than sufficient for the workload that is not memory intensive (1 to 5 MB/s). In such cases, the software overhead may be further reduced by sampling the throughput traffic for a window that is larger than the configured short sample window.

An automatic way to do this is to calculate the counter threshold as:

threshold=max(max_mbps,floor_mbps)*short_sample_window
Where, floor_mbps is the minimum throughput a workload should generate in a short sample window to be considered a memory intensive enough to warrant the short sample window.

In architectures where mathematical instructions like division and multiplication are expensive, the threshold can be recomputed only every decision window to reduce the software overhead at the end of each short sample window.

### Deciding the Throughput Vote at the End of Decision Window

The decision window is typically configured such that changing the memory/bus frequency more often than the time of the decision window would typically be considered as changing the memory/bus frequency too often. However, the bus master's memory access traffic could be bursty and sporadic such that all, or a majority, of the traffic happens within a small duration of the decision window.

The use of a short sample window for each short sample loop enables a better assessment of the traffic pattern within a decision window. The short sample window is typically configured to be small enough to distinguish between parts of the decision window where there is consistently heavy traffic from the parts where there is little to no traffic. If too small of a short sample window is picked, the high resolution picture of the traffic might end up being too burst/noisy. The right short sample window length will depend on the characteristics of the bus master generating traffic and the typical nature of their traffic.

Assuming the short sample window and the decision window are configured appropriately for the bus master and the overall system, the maximum throughput measured amongst all the short sample windows within a decision window would give the maximum throughput that was used by the bus master within the decision window.

Therefore, the required throughput for the decision window may be computed as: req_mbps=max_mbps.

### Significant Traffic Changes and Early Termination of Decision Window

When the traffic change is significant enough to warrant an increase or decrease in the current throughput vote, the decision window is terminated early and the throughput vote is recomputed. The criteria for this may be exposed as the following configurable parameters by the MAMs 110: up_thres, down_thres, up_count and down_count.

At the end of each decision window, up_thres_mbps and down_thres_mbps are computed as:

up_thres_mbps=(max_mbps*(100+up_thres))/100

down_thres_mbps=(max_mbps*down_thres)/100.

And the current decision window is terminated early if at the end of a short sample window any one of the following conditions are met:
The short_sample_mbps is greater than or equal to up_thres_mbps in more than up count short sample windows within the current decision window. The short_sample_mbps is less than or equal to the down_thres_mbps in more than down_count short sample windows (optionally, consecutive short sample windows) within the current decision window.

### Over Estimating Required Throughput to Stay Ahead of Increasing Traffic

When the decision window is terminated early due to a significant increase in the traffic, it is very likely that the traffic would continue to increase. The MAMs 110 may try to predict that growth ahead of time by over estimating the required throughput when the decision window is terminated early due to significant increase in the load.

When there is a significant increase in traffic, the MAM 110 may over estimate the required throughput in proportion to the increase in traffic as follows:

req_mbps=max_mbps+((max_mbps−prev_req_mbps)*up_scale/100)

Where,
prev_req_mbps is the req_mbps of the previous decision window; and
up_scale is a configurable parameter. Referring again to FIG. 7, the voting level is overestimated at about 9.92, 10.060, and 10.065 seconds in anticipation of a continuing increase in traffic.

When there is no significant increase in traffic, the required throughput may be computed as previously explained.

Because the required throughput is no longer the same as the maximum throughput (max_mbps), the early termination of the next decision window is only necessary when the measured traffic significantly exceeds the required throughput. Therefore, the calculation of up_thres_mbps is also changed to be:

up_thres_mbps=(req_mbps*(100+up_thres))/100.

### Power Awareness in Over Estimating Throughput

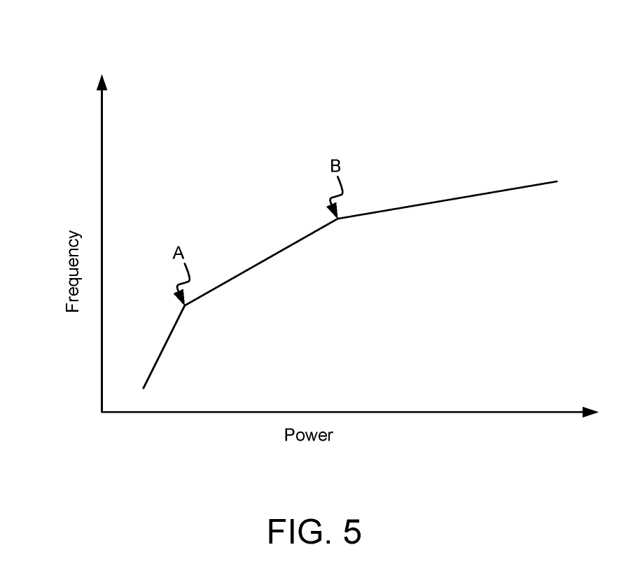

A plot of the throughput capacity over power for all the frequencies supported by a memory or bus is not always a straight line. The plot typically has a few frequencies, where the slope of the plot decreases significantly. So, picking a frequency just above these points only because of over estimation would be very inefficient with respect to power. In the example diagram depicted in FIG. 5, it would be points A and B.

To avoid this, the algorithm takes as input a list of these crossover points (in units of AB vote, IB vote or frequency) and makes sure the final AB and IB votes (as discussed further herein in more detail) do not exceed these points just because of over estimation. For example, if the IB vote without any overestimation would result in a value between A and B in the plot in FIG. 5, then the algorithm will set an upper limit for the overestimated IB value to B. The same is done for the AB vote.

### Historic Peak Tracking and Limiting Over Estimation

Although the over estimation of required throughput when there is a significant increase in traffic is good for performance, over estimation can cause a lot of unnecessary power consumption if the traffic doesn't continue increasing as predicted. Referring yet again to FIG. 7, at about 10.1 seconds, over estimation results in voting that may result in unnecessary frequency increases, and hence, unnecessary power consumption. Therefore, the extent of over estimation of the required throughput may be tempered by looking at maximum traffic throughput seen in the most recent hist_memory decision windows.

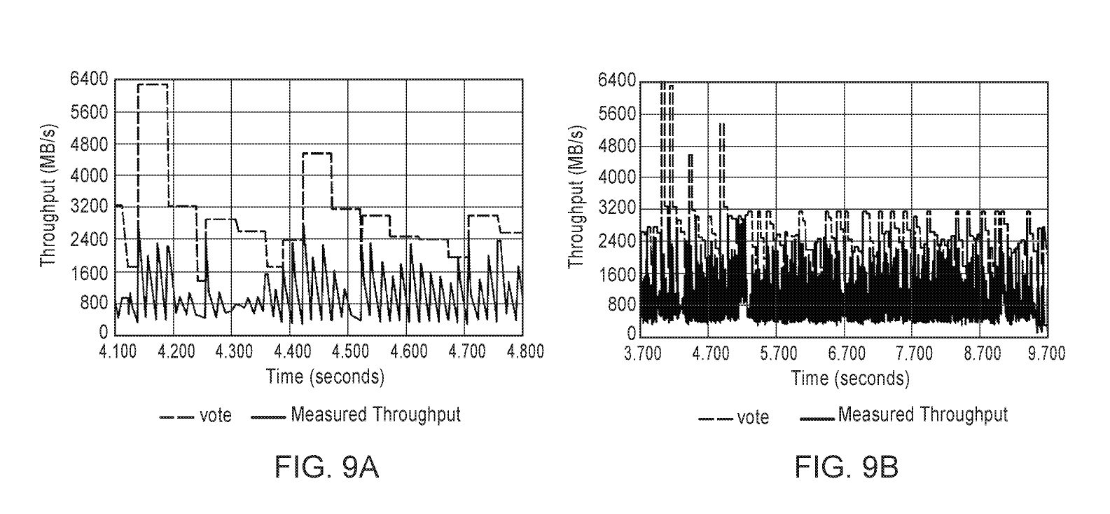

As long as the max_mbps of the early terminated decision window (e.g., a decision window terminated early due to a significant increase in traffic) is less than the maximum traffic throughput seen in the most recent hist_memory decision windows, an upper limit may be set on the over estimation of the required throughput to the maximum traffic throughput seen in the most recent hist_memory decision windows. Referring to FIGS. 9A and 9B, for example, the voting levels are limited to the historic peaks if the throughput is less than a historic peak. FIG. 9A depicts an exploded portion (from 4.1 to 4.8 seconds) of the graph in FIG. 9B. If the max_mbps of the early terminated decision window is greater than this maximum traffic seen in the most recent hist_memory decision windows, the over estimation of required throughput is not limited in any way.

In some implementations, when the method depicted in FIG. 4 starts, the historical peak (hist_max_mbps), is set to 0. If the max_mbps of a decision window is greater than hist_max_mbps, then hist_max_mbps is updated to this new max_mbps. Any time the hist_max_mbps is updated, the algorithm remembers hist_max_mbps for the next hist_memory decision windows. If hist_memory decision windows pass without any updates to the hist_max_mbps, then hist_max_mbps is updated to the max_mbps of the last/latest decision window and this new hist_max_mbps is remembered for the next hist_memory decision windows.

In addition, the duration for which the current hist_max_mbps is remembered may be extended if a specific decision window sees a max_mbps between 100% and hist_peak_tolerance % (a value less than 100%) of hist_max_mbps. When this happens, it extends the duration to remember the current hist_max_mbps to be hist_memory decision windows from that specific decision window.

As shown in FIG. 9B, after about 5.2 seconds, historic peak tracking and the above-detailed limitations to overestimation effectively limit the value of the voting (even though the measurements remain about the same) to prevent excessive over voting.

As shown in FIG. 9A, after about 4.7 seconds, historic peak tracking and the above-detailed limitations to overestimation effectively limit the value of the voting to the historic peak that happened after about 4.4 seconds and avoids excessive over voting.

The use of hist_peak_tolerance % is helpful because it extends the duration for which the historic peak is remembered and thereby reduces the possibility of a full overestimation of the required throughput.

Assume for example, hist_memory is 10, up_scale is 200% and the current historical peak is 2000 MB/s. If the next 15 decision windows see a max_mbps and req_mbps of 1800 MB/s and the 15^{th} decision window sees a max_mbps of 1900 MB/s, without a hist_peak_tolerance %, the req_mbps for the 15^{th} decision window would be overestimated to 1900+(1900−1800)*200/100=2100 MB/s. With hist_peak_tolerance % of 80%, the historical peak would be remembered into the 15^{th} decision window and would have limited the overestimated req_mbps to 2000 MB/s.

### Pattern Detection and Predicting Required Throughput

Another enhancement to the method depicted in FIG. 4 may be detecting patterns in the traffic throughput; attempting to predict increases in the required throughput of future decision windows; and voting for the predicted required throughput ahead of time so that the throughput vote is already sufficient when the traffic throughput increases.

First, the hysteresis throughput (hyst_mbps) to vote for when a pattern is detected by the algorithm is determined by keeping track of the highest max_mbps seen in N (hyst_length) consecutive decision windows. Within those windows, as soon as there are M (hyst_trigger_count) instances where the max_mbps of a decision window is greater than or equal to a predefined percentage (hyst_tolerance %)(a value less than 100%) of hysteresis throughput (hyst_mbps), the algorithm then enables hysteresis mode. Hysteresis mode keeps the required throughput (req_mbps) at least at (can go higher than) hysteresis throughput for the next hyst_length decision windows.

If hysteresis throughput (hyst_mbps) increases in a decision window before hysteresis mode is enabled, then the hyst_length decision windows over which hyst_trigger_count tracking is done is reset to start from that decision window.

When the hysteresis mode is already enabled, if the hysteresis throughput increases or if the max_mbps of a decision window is greater than or equal to hyst_tolerance % of hysteresis throughput, the hysteresis mode may be extended for other hyst_length decision windows from that decision window.

For example, if hyst_trigger_count is 3 and hyst_length is 10, then a traffic throughput pattern where 10 consecutive decision windows have a max_mbps of 1000, 200, 1000, 200, 1000, 200, 1000, 200, 1000, 200 MB/s, respectively will cause the required throughput to stay at 1000 MB/s after the 6th decision window and will stay at least 1000 MB/s for the next 10 decision windows. Thus, when the 8th and 10th decision windows require 1000 MB/s, the throughput vote would already be at 1000 MB/s.

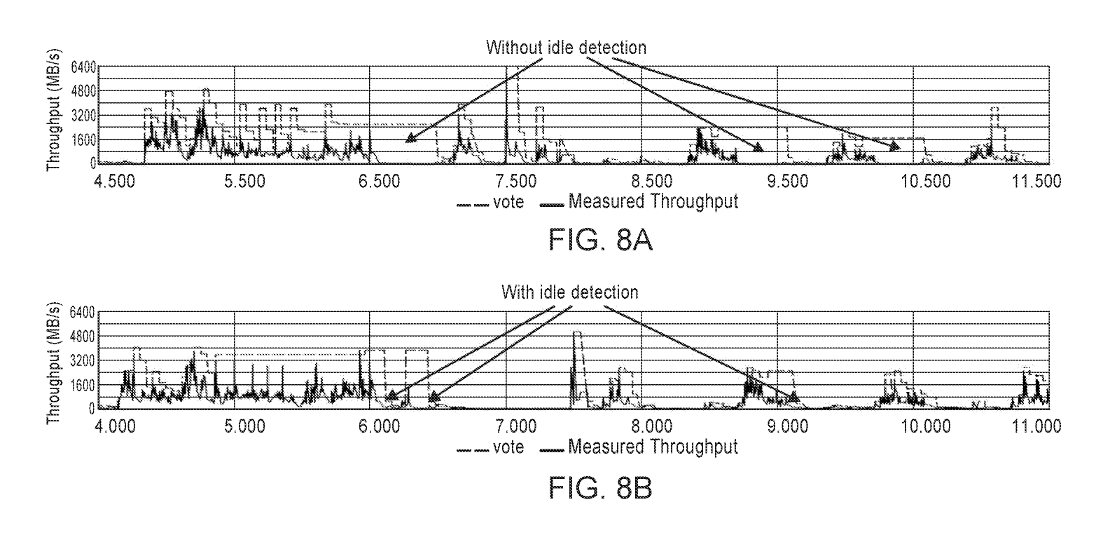

Referring to FIG. 8A for another example in graphical form, between about 5.5 seconds and 6.5 seconds, a pattern is not sufficient enough to trigger pattern detection. In contrast, as shown in FIG. 8B between about 5 seconds and 6 seconds, pattern detection operates to maintain the required throughput at a higher level to effectively accommodate the peak throughput levels.

Suppressing Hysteresis Mode when Traffic Ends

Although hysteresis mode is very helpful to achieve good performance, it still wastes some power when it keeps the required throughput vote much higher than necessary when the traffic abruptly comes to an end or the HW device 102 goes idle. Referring to FIG. 8A for example (where arrows point out where idle detection is not utilized), the throughput vote is unnecessarily high. This is quite common for HW devices like the CPU 272 where work load can change very quickly. In contrast, FIG. 8B depicts (where the arrows point out where idle detection is effectuated) the required throughput vote dropping when traffic stops; thus avoiding an unnecessary draw of power.

The stop in traffic may be detected by checking if the max_mbps of a decision window is less than an idle_mbps threshold. If the max_mbps of a decision window is below idle_mbps, then the MAM 110 suppresses hysteresis mode for that decision window and determines the required throughput as if hysteresis mode was never enabled. To be clear, in many implementations the MAM 110 does not turn off hysteresis mode and go back to pattern detection mode, it just suppresses hysteresis mode for that decision window. Guard band and adjusted throughput

Despite Having a Low Latency Reaction Time Due to Short Sample Windows and early termination of decision windows, it still takes a non-trivial amount of time (in a relative sense) to notice an increase in throughput, make new AB/IB votes to the bus driver and result in a change of the actual DDR/bus frequency. This could cause negative performance impact.

To account for additional data that could be transferred while memory/bus is at the lower frequency before the frequency is increased, a guard_band_mbps (MB/s) may be added to the required throughput before it used to compute the AB/IB votes.

adjusted_mbps=req_mbps+guard_band_mbps.

A distinction to make is that the guard_band_is not applied when computing the up_thres_mbps for a decision window because doing so would dramatically reduce the effectiveness of the guard band.

### Decay Rate to Avoid “Ping-Pong” and Frequent Changes

Computing the AB/IB votes without any historical context can result in the AB/IB votes changing frequently due to bursts of read/writes from the CPU 272 or other bus master. To avoid frequent ping-pongs of AB/IB values and thereby frequent ping-pongs of memory/bus frequencies, the effective throughput may be calculated by doing a cumulative weighted average of the adjusted throughput and the previous effective throughput.

However, to avoid any negative performance impacts, the history is completely ignored and the effective throughput is considered to be the same as adjusted throughput when the latter is greater than the former.

When the adjusted throughput is lower than the previous effective throughput, the decay_rate tunable parameter is used to compute the effective throughput, where decay_rate is the percentage of the previous effective throughput that's discarded.

In short, the effective throughput is computed as follows:

When, adjusted throughput is higher than previous effective throughput

eff_throughput=adjusted_mbps

Otherwise,

eff_throughput=((100−decay_rate)*previous_eff_throughput+decay_rate*adjusted_mbps)/100

### Computing AB and IB-IO Percent and Rounding Up

In some embodiments, computing the AB vote is simply the effective throughput rounded up to multiples of bw_step. The rounding up of effective throughput is useful to avoid frequent minute changes to the AB vote that would trigger a lot of unnecessary aggregation work on the memory/bus frequency control component 112 on the application processor and communication with the memory/bus clock controller 108 (to complete the system-wide AB aggregation) without any real or significant change to the memory/bus frequency.

AB=((effective_throughput+bw_step−1)/bw_step)*bw_step.

The logic behind computing the IB vote is a bit more complicated. The IB vote is what affects the latency of the read/writes between the CPU 272 and system memory 282.

Assuming, for example, some amount of data was transferred between the CPU 272 and system memory in a sample period. In general, that transfer is a result of the CPU 272 doing some work that does not require memory access and some work that does access the memory. In other words, the data transfer to memory is just a percentage of the work that the CPU 272 performed in that sample period. This percentage of time the CPU 272 is allowed to spend accessing the memory is a tunable parameter referred to as io_percent.

If the CPU 272 transferred X MB in sample_ms milliseconds and the memory/bus frequency is set up to allow X MB of transfer per sample_ms milliseconds, then if the CPU 272 repeats the exact same work load for the next sample_ms milliseconds it will spend the entire sample_ms milliseconds transferring X MB due to the high latency and won't have time to do any other work that doesn't access DDR.

Since the CPU 272 only spends io_percent percentage of its time transferring data to memory, the memory/bus needs to be configured to support 100/io_percent times the effective_throughput. That way, if the CPU 272 repeats the exact same work load, it will only spend io_percent*sample_ms/100 milliseconds doing data transfer with the memory.

Therefore, ib=eff_throughput*100/io_percent.

Because the memory/bus only have a finite set of frequencies it can run at and the bus driver aggregates the IB votes by doing a maximum of the votes (rather than the summation that's done for AB), before sending the CPU/bus master IB vote to the memory/bus frequency controller, it is rounded up to the smallest supported discrete IB level that is greater than or equal to the computed IB value. This rounding up of IB is purely an optimization that reduces some work done on the application processor bus driver and does not reduce any communication to the memory/bus clock controller 108. The rounding up of the AB on the other hand does reduce communications to the memory/bus clock controller 108 because the final AB aggregation is done on the memory/bus clock controller 108.

### Detecting Low Power Mode and Picking a Larger IO Percent

When the measured traffic is consistently low, it either means that the HW device 102 is doing a lot of work, but only a tiny fraction is memory intensive, or the HW device 102 is running at one of its lower performance modes but is doing moderately memory intensive work. In both these cases, it might be more efficient to run the memory and bus a bit slower and have the HW device 102 either be unaffected or move up one or two performance levels respectively.

This may be achieved by using a low_power_io_percent instead of io_percent in the calculation of IB when low power delay consecutive decision windows have a max_mbps value that's less than low_power_ceil_mbps. This ensures that the more power friendly (higher value than io_percent that results in a smaller IB) low_power_io_percent is only used when we are consistently and clear in a low power mode. The algorithm uses max_mbps for comparison against low_power_ceil_mbps so that the low power mode detection is not affected by any incorrect (where traffic doesn't increase as predicted) over estimations of required throughput.

### Hardware Implementations

As discussed above, the high frequency sampling performed by each of the MAMs 110 may be implemented in software in connection with a hardware counter 104 with threshold interrupt (IRQ) support, but this type of implementation may incur overhead that prevents it from having an ideal implementation (e.g., that includes fixed sized, short sample windows) and may also limit use in connection with HW devices 102. For example, when the MAMs 110 are realized by software, it may be possible to only monitor a single HW device 110 (e.g., only the CPU 272 instead of the CPU 272, GPU 287, and crypto engine 202) to avoid too many CPU 272 wake ups).

In other embodiments, some or all of the components of the MAMs 310 may be implemented in hardware to significantly remove software-related overhead (e.g., interrupts every few milliseconds) and software-related complexity (e.g., smart stretching of windows).

### Tracking Samples to Trigger IRQ for Quick Reaction Time

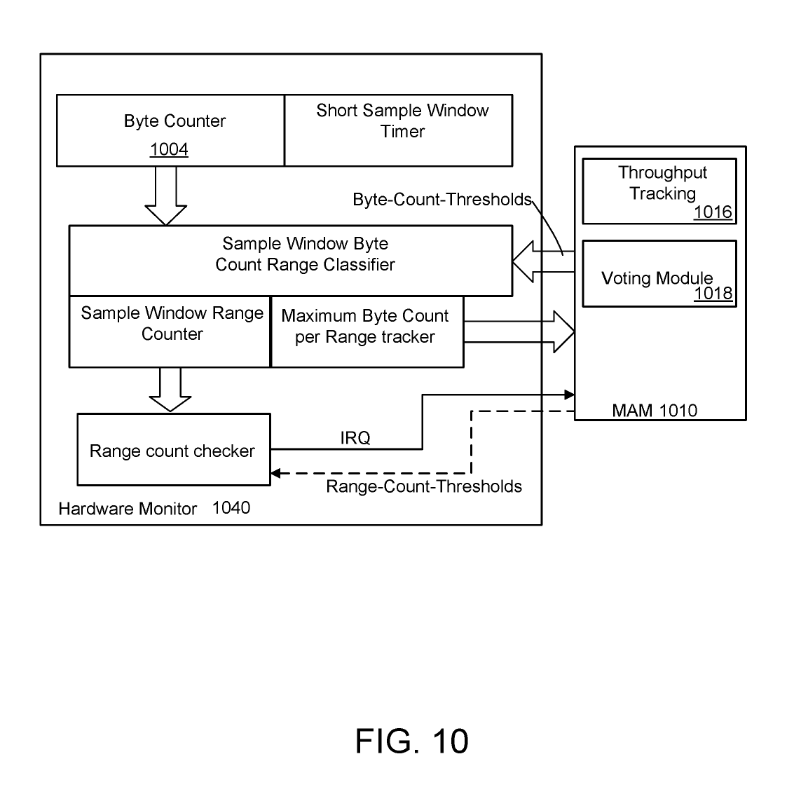

Referring to FIG. 10, shown is a hardware monitor 1004 that may be utilized to implement the functionality of the short sample processing module 312 and the decision loop processing module 314. As shown the hardware monitor 1004 includes a byte counter coupled to a short sample window timer and a sample window byte-count-range-classifier module. The sample window byte-count-range-classifier module is coupled to a sample window-range counter and maximum byte count per range tracker. In addition, the sample window-range counter is coupled to a range count checker, which is coupled to the MAM 1010 that includes the throughput tracking module 1016 and the voting module 1018.

In this embodiment, the byte counter 1004 operates in the same way as the counters 104, 204 described above. And the short sample window timer operates to control the short sample window timing functionality of the short sample processing component 312. The sample window byte-count-range module enables the MAM 1010 to specify two or more byte count ranges. For example, three byte count ranges may be set up: 1) less than LOMB; 2) between 10 MB and 20 MB; and 3) greater than 20 MB. And at the end of each short sample loop, the sample window-range counter keeps a count of the range the byte count of the short sample window fell into. In some implementations, the sample, window range counter may also clear a specific range's count if a short sample window falls into another range. In this embodiment, for each of these per-range sample counts, the range count checker enables a threshold to be established. And when the sample count exceeds a threshold, an IRQ is generated and sent to the MAM 1010.

Periodically or in response to an IRQ, the throughput tracking module 1016 of the MAM 1010 will read the maximum byte counts, which the voting module 1018 utilizes to decide the frequency the memory/bus should be running at.

Hardware that Self-Adjusts Performance

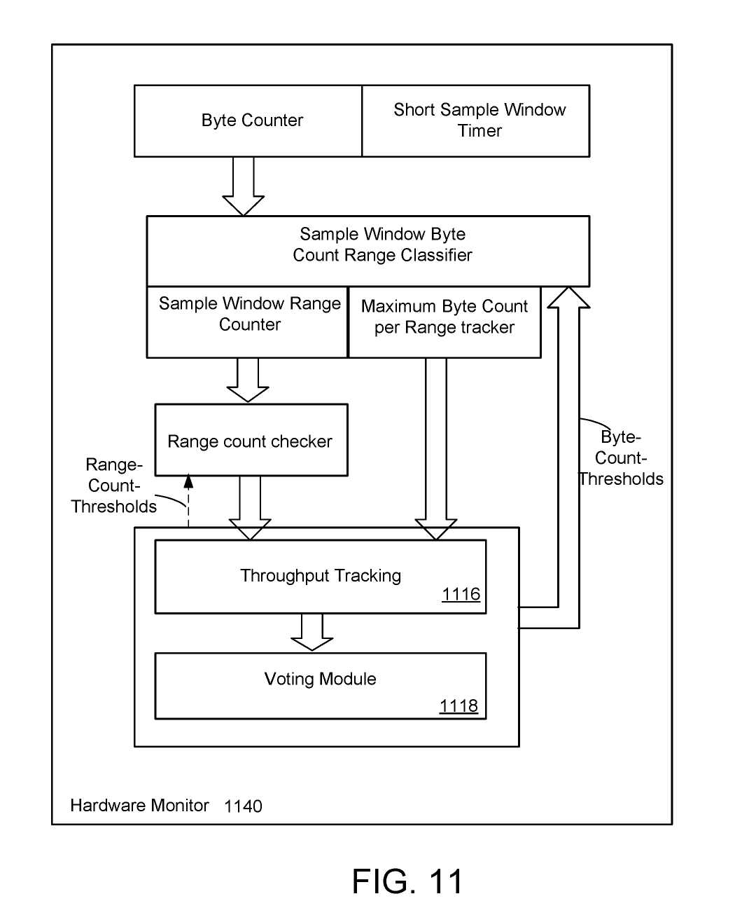

Referring next to FIG. 11, shown is a hardware monitor 1140 that is capable of performing the method described with reference to FIG. 4. As shown, the hardware monitor 1140 includes the same components of the hardware monitor 1040 depicted in FIG. 10, but in addition, the hardware monitor 1140 also includes a throughput tracking module 1116 and a voting module 1118. In this embodiment, the hardware monitor 1140 has the final memory throughput vote for the master its monitoring and it can directly send it to the memory/bus frequency controller 112.

This embodiment allows the frequency of the memory to be scaled to account for all variable traffic from masters without real time requirements in hardware and without any software interference. Real time requirements means that read/write requests to memory must finish within a particular time. Otherwise, they will stop functioning correctly. For example, while the screen is drawing line X in the screen, the display hardware reads from memory the data for line X+1. This reading of data needs to finish before the screen is done with drawing line X. If the read does not finish on time, then what will be seen on the screen will not be what is intended. Real time masters, like a display, camera, etc., that have predetermined and well known throughput requirements can still have their software drivers make their votes to the memory/bus frequency controller 112.

To conclude, the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a processor, a DSP, an Application Specific Integrated Circuit (ASIC), an FPGA or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for controlling frequency of at least one of system memory and a system bus on a computing device, the method comprising:
computing, within each of a plurality of decision loops, a maximum data throughput between a hardware device and the system memory, each decision loop lasting for a decision-loop-duration;
monitoring, during a plurality of short sample loops within each of the decision loops, a number of bytes transferred, via the system bus, to and from a hardware device to enable the computing of the maximum data throughput between the hardware device and system memory, wherein each of the short sample loops lasts for a sample-loop-duration;
generating, after each decision loop, a throughput vote for the hardware device; and
controlling the frequency of at least one of system memory and a system bus based upon an aggregation of votes including the throughput vote for the hardware device.

2. The method of claim 1, including:
maintaining the throughput vote at a particular level based upon the maximum data throughput reaching a predefined percentage of the particular level M times within N consecutive decision windows.

3. The method of claim 1, including:
setting a counter threshold=max_mbps*short_sample_window;
where, max_mbps is a maximum throughput measured in any short sample loop within a previous decision loop, short sample window is the sample-loop-duration of each short sample window; and
an arrival of a threshold interrupt indicates an end of each short sample loop so the sample-loop-duration increases in response to a decrease in the data throughput.

4. The method of claim 1, wherein the decision-loop-duration is terminated when a change in the data throughput exceeds a threshold.

5. The method of claim 4, wherein the throughput vote is based upon a required throughput=max_mbps+((max_mbps−prev_req_mbps)*up_scale/100)
where max_mbps is the maximum data throughput during the decision loop, prev_req_mbps is a required throughput of a previous decision loop, and up_scale is a configurable parameter.

6. The method of claim 5 including:
comparing the throughput vote to a list of throughput crossover points; and
reducing the throughput vote to a throughput crossover point to prevent an unnecessary draw of power.

7. A computing device comprising:
a hardware device;
system memory coupled to the hardware device;
a system bus coupled between the system memory to the hardware device;
a counter coupled to the hardware device;
a memory access monitor coupled to the counter that is configured to:
compute, within each of a plurality of decision loops, a maximum data throughput between a hardware device and the system memory, each decision loop lasting for a decision-loop-duration;
monitor, during a plurality of short sample loops, within each of the decision loops, a number of bytes transferred, via the system bus, to and from a hardware device to enable the computing of the maximum data throughput between the hardware device and system memory, wherein each of the short sample loops lasts for a sample-loop-duration;
generate, after each decision loop, a throughput vote for the hardware device; and
a memory/bus frequency control module configured to control the frequency of at least one of system memory and a system bus based upon an aggregation of votes including the throughput vote for the hardware device.

8. The computing device of claim 7, including:
maintaining the throughput vote at a particular level based upon the maximum data throughput reaching a predefined percentage of the particular level M times within N consecutive decision windows.

9. The computing device of claim 7, wherein the memory access monitor is configured to set a counter threshold=max_mbps*short sample window;
where, max_mbps is a maximum throughput measured in any short sample loop within a previous decision loop, short sample window is the sample-loop-duration of each short sample window; and
an arrival of a threshold interrupt indicates an end of each short sample loop so the sample-loop-duration increases in response to a decrease in the data throughput.

10. The computing device of claim 7, wherein the memory access monitor is configured to terminate the decision-loop-duration when a change in the data throughput exceeds a threshold.

11. The computing device of claim 10, wherein the throughput vote is based upon a required throughput=max_mbps+((max_mbps−prev_req_mbps)*up_scale/100)
where max_mbps is the maximum data throughput during the decision loop, prev_req_mbps is a required throughput of a previous decision loop, and up_scale is a configurable parameter.

12. The computing device of claim 11 wherein the memory access monitor is configured to:
compare the throughput vote to a list of throughput crossover points; and
reduce the throughput vote to a throughput crossover point to prevent an unnecessary draw of power.

13. A non-transitory, tangible processor readable storage medium, encoded with processor readable instructions to perform a method for controlling frequency of at least one of system memory and a system bus on a computing device, the method comprising:
computing, within each of a plurality of decision loops, a maximum data throughput between a hardware device and the system memory, each decision loop lasting for a decision-loop-duration;
monitoring, during a plurality of short sample loops, within each of the decision loops, a number of bytes transferred, via the system bus, to and from a hardware device to enable the computing of the maximum data throughput between the hardware device and system memory, wherein each of the short sample loops lasts for a sample-loop-duration;
generating, after each decision loop, a throughput vote for the hardware device; and
controlling the frequency of at least one of system memory and a system bus based upon an aggregation of votes including the throughput vote for the hardware device.

14. The non-transitory, tangible processor readable storage medium of claim 13, including:
maintaining the throughput vote at a particular level based upon the maximum data throughput reaching a predefined percentage of the particular level M times within N consecutive decision windows.

15. The non-transitory, tangible processor readable storage medium of claim 13, including:
setting a counter threshold=max_mbps*short sample window;
where, max_mbps is a maximum throughput measured in any short sample loop within a previous decision loop, short_sample_window is the sample-loop-duration of each short sample window; and
an arrival of a threshold interrupt indicates an end of each short sample loop so the sample-loop-duration increases in response to a decrease in the data throughput.

16. The non-transitory, tangible processor readable storage medium of claim 13, wherein the decision-loop-duration is terminated when a change in the data throughput exceeds a threshold.

17. The non-transitory, tangible processor readable storage medium of claim 16, wherein the throughput vote is based upon a required throughput=max_mbps+((max_mbps−prev_req_mbps)*up_scale/100)
where max_mbps is the maximum data throughput during the decision loop, prev_req_mbps is a required throughput of a previous decision loop, and up_scale is a configurable parameter.

18. The non-transitory, tangible processor readable storage medium of claim 17 including:
comparing the throughput vote to a list of throughput crossover points; and
reducing the throughput vote to a throughput crossover point to prevent an unnecessary draw of power.
